(19) United States
(12) Patent Application Publication
(10) Pub. No.: US 2013/0159036 A1
(43) Pub. Date: Jun. 20, 2013

(54) RUNTIME GENERATION OF INSTANCE CONTEXTS VIA MODEL-BASED DATA RELATIONSHIPS

(71) Applicants: Ulrich Keil, Heidelberg (DE); Jochen Mayerle, Flein (DE); Marianne Brosche, Heidelberg (DE); Joachim Fessler, Grafenberg (DE); Holger Knospe, Wiesloch (DE)

(72) Inventors: Ulrich Keil, Heidelberg (DE); Jochen Mayerle, Flein (DE); Marianne Brosche, Heidelberg (DE); Joachim Fessler, Grafenberg (DE); Holger Knospe, Wiesloch (DE)

(21) Appl. No.: 13/325,605

(22) Filed: Dec. 14, 2011

(51) Int. Cl. G06Q 10/06

(52) U.S. Cl. 705/7.12

(57) ABSTRACT

A seed element can be determined by identifying a business object type underlying a current use context of a currently active application environment experienced by a user of a business software architecture. At runtime, a data context can be populated by applying a set of data derivation rules stored in a meta-model to compare the seed element to a plurality of business object instances retained in memory. Status and responsibility rules stored in the meta-model can be evaluated based on the data context to build a set of up-to-date process or scenario instance information. A process navigation user interface configuration presentable on a computer display device can display up-to-date instance information relating to the current use context for a business process or scenario instance related to the current use context.

### CROSS-REFERENCE TO RELATED APPLICATIONS

The current application is related to the following co-pending and co-owned U.S. patent applications, the disclosure of each of which is incorporated herein in its entirety: [[Attorney docket nos. 34874-774F01US/2011P00201US, 34874-760F01US/2011P00149US, 34874-763F01US/2011P00166US, 34874-764F01US/2011P00167US, 34874-765F01US/2011P00168US, 34874-766F01US/2011P00169US, 34874-768F01US/2011P00171US, 34874-769F01US/2011P00172US, 34874-770F01US/2011P00173US, 34874-771F01US/2011P00174US, 34874-772F01US/2011P00175US, 34874-773F01US/2011P00198US, and 34874-781F01US/2011P00363US]].

### TECHNICAL FIELD

The subject matter described herein relates generally to enhancing user interaction with, and navigation among, features, functions, controls, and the like of an integrated software suite, such as for example an enterprise resource planning solution.

### BACKGROUND

Modern integrated business software solutions, such as for example those with enterprise resource planning (ERP) feature sets, can assist users in performing a wide variety of business related tasks that can typically be grouped into business scenarios, business processes, or the like that can include one or more business process features and that may require action (e.g. completion of one or more tasks) by a large number of employees or other members of an organization. One or more business processes can be further grouped into a business scenario, which can be considered as a higher-level classification of related business processes. Each process step that is part of a business process can be associated with one or more user interface elements, screens, and the like via which a user interacts with specific software components to perform tasks related to completion of the process step. A complicated business process can involve multiple process steps, which can optionally be grouped into one or more sub-processes, and each step can include one or more tasks that may require interaction with the functionality of one or more feature modules of an enterprise resource planning (ERP) software system.

An ERP system, by definition, implements business processes. If the ERP system is process based, then business process models exist. If, in addition these models are operational models, i.e. models that have operational links to the implementation details of the system, then the problem of assembling business process instance data can be addressed. Business processes that are driven by a process engine can include a process instance log that contains all the information required to visualize such an instance. If, however, the business processes are not driven or monitored by a process engine, then there is no single authoritative source for storing process context data and status information. In that case, the details of a process instance can be assembled at run time. However, run time assembly of process instance data without access to a persistent process log can require construction or reconstruction of all process relevant data and object relations based on rules that act on the context information available at the time of the request. Such an on-the-fly assembly of process instances can create challenges in assembling the data instances that participate in the process instance, starting from a concrete entry point (e.g. the seed or reference object or user interface feature). For example, if a user is working on a specific sales order in can be necessary to determine that the specific sales order is connected or otherwise related to a specific customer quote, to a specific customer project, etc. The set of all data entities related to the seed or reference object or user interface feature in the context of the given process instance can be referred to as the data context of that process instance.

Based on the data context, the current status of each business process feature within a business scenario), the list of responsible persons, pending deadlines, etc. can be derived via rules that interpret attributes of the data context of the business process instance or the business scenario instance. Accordingly, retrieval of all data entities that together form the data context of a specific scenario or process instance can be necessary to enable revealing to a user the specific process instance in which he or she is currently working and how that process instance fits into an overall business scenario instance.

### SUMMARY

In one aspect, a method includes determining a seed element by identifying a business object type underlying a current use context of a currently active application environment experienced by a user of a business software architecture. At runtime, a data context is populated by applying a set of data derivation rules stored in a meta-model to compare the seed element to a plurality of business object instances retained in memory. Status and responsibility rules stored in the meta-model are evaluated based on the data context to build a set of up-to-date process or scenario instance information, and up-to-date instance information relating to the current use context for a specific instance of the business process or scenario related to the current use context is displayed via a scenario navigation user interface configuration presentable on a computer display device.

In some variations one or more of the following features can optionally be included in any feasible combination. The determining the seed element can optionally further include identifying a reference business object underlying the currently active application environment. The populating can optionally include identifying other specific business object instances that are related to the specific instance of the business process or scenario from the plurality of in-memory business object instances. The meta-model can optionally be updated based on a received user input. The scenario navigation user interface configuration can optionally include a navigation pane of the user interface that includes a plurality of first user interface elements illustrating a sequence of a plurality of business process features required for completion of the specific instance of the business process or scenario and a status of one or more of the plurality of business process features for the specific instance of the business process or scenario. The navigation pane can optionally be concurrently displayed with a work pane that includes second user interface elements related to the currently active application environment.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows another screenshot of a user interface illustrating a structured business scenario detail view;

FIG. 2 shows a graphical depiction of features of a process consistent with implementations of the current subject matter;

FIG. 3 shows another graphical depiction of features of a process consistent with implementations of the current subject matter;

FIG. 4 is a process flow diagram illustrating aspects of a method having one or more features consistent with implementations of the current subject matter;

FIG. 5 is a diagram illustrating aspects of a system showing features consistent with implementations of the current subject matter;

FIG. 6 is a diagram illustrating aspects of a system showing features consistent with implementations of the current subject matter; and

FIG. 7 is a diagram illustrating a data repository showing features consistent with implementations of the current subject matter.

When practical, similar reference numbers denote similar structures, features, or elements.

### DETAILED DESCRIPTION

Integrated end-to-end business scenarios (as an illustrative example, an order scenario that begins with generation of a sales quote and terminates with payment received) can be quite complex. A user can have difficulty understanding precisely where a specific instance of the business scenario is along the sequence of business process features (e.g. business processes, process steps, sub-processes, tasks, etc.) that need to be performed to bring the business scenario to completion. For example, a user may wish to know where a business scenario instance (e.g. the delivery of a sales order) is in the scenario, if and why and at what point in the scenario a business scenario instance has become stuck (e.g. progress has temporarily halted because an approval is necessary, but has not been done), and what needs to happen next and who is the responsible user. If the user has the authority rights, he or she can perform tasks or other activities related to a business process feature directly from the monitor.

To address these and potentially other issues with currently available solutions, methods, systems, articles of manufacture, and the like consistent with one or more implementations of the current subject matter can, among other possible advantages, provide the ability to dynamically build a data context of a scenario instance. According to some implementations, a seed (e.g. an initial data object instance) can be identified at runtime and all available dependent data objects can be dynamically derived via data relations that are stored as part of a metadata definition of an underlying process or scenario model. Ad-hoc modeling of such relations can be added as an extension to the process or scenario model. In other words, a business scenario can be enhanced at any time (for example after a formal establishment of a business configuration of the business software architecture for an organization), by adding extra relations to the scenario model that allow capturing additional data objects. These additional data objects need not have been initially defined as being associated with the business process or scenario. An approach consistent with implementations of the current subject matter can thereby allow adding data relations without coding. For example, if an external software provider, partner, etc. adds functionality, includes additional business process features (e.g. business process features external to the core software platform of the business software architecture), or requires additional data that the creator(s) of the process or scenario model may not have foreseen, the process or scenario model can be updated accordingly. The flexibility of extending a process or scenario model can thereby be provided to an external software provider partner, a business process expert at a customer's site, or even to an end user who executes tasks in the process.

A scenario landscape for an organization can refer to a set including all or some of the business scenarios and/or business processes characterizing an organization's operations. In general a business scenario can includes one or more business processes, process steps, or other business process features. Business process features can include, but are not limited to, one or more of business processes, process steps, sub-processes, tasks, activities, and the like. The business scenarios and business processes can be managed, and tasks relating to the completion of one or more steps of the business processes can be supported by, one or more feature modules of a business software architecture, such as for example an enterprise resource planning (ERP) system. The terms “instance of a business process,” “instance of a business scenario,” and similar descriptive terminology is intended to refer to a specific execution of a business process or a business scenario, respectively. For example, for a business scenario relating to sale of a product, each order taken and filled for that product can be considered as an instance of the business scenario. A business configuration can be a set of business scenarios including sets of business processes or business process features supported by the business software architecture and optionally customized to reflect the actual, real-life business functions (e.g. end-to-end business processes) performed by employees or other organization members on a recurring basis. A business configuration for an organization customer of a business software architecture is usually set up upon initial installation with occasional modifications or updates provided to reflect changes to the underlying real-life processes and procedures. Such a business configuration is typically constructed like a catalog, and its functions can be structured according to business areas, packages, topics and options. Once the initial business configuration is set up, all decisions are made, and the scoping is done, the business software architecture is ready for productive usage.

A business scenario meta-model of a business scenario can include a declaration of a list of the data entities on which the business scenario operates. For example, a list of uniquely named and fully typed data entities can be included as part of the scenario model and/or as part of individual process model of the business processes that make up the business scenario. There may be any number of data entities of the same type (e.g.: several sales order objects) that may play a more than one semantically different role (e.g. one sales order for an internal and one for an external consultant), so assignment of a unique name or other identifier associated with each data entity can assist in making them fully distinguishable in a deterministic manner.

Once the data context has been specified, a modeling tool can enable a (technical) business expert to express the relations between (nested) attributes of the various business objects in the process or scenario context. Such relations can be expressed graphically, for example as lines between a source data structure and the target object or in textual form, in which a data access can be expressed as a path expression that describes how to traverse the source data structure, together with an operator that defines how to assign or transform the source data entity to the target object. Such data relations can be directed, for example “from attribute A of object S to another object T,” which expresses that the object T can be obtained by reading (and optionally transforming) the attribute A of the object S. Attribute access can be nested. For example, it can be necessary to follow a chain of attributes to arrive at the desired target data object.

At runtime, the entire set of such data relations modeled by the process or scenario meta-model for a business process or scenario can be used to iteratively examine attributes of objects already known to belong to the process or scenario instance, access their attributes, and attempt to derive new object instances along the modeled paths that can be added to the data context of the process or scenario instance. Once this process stabilizes, for example, once further evaluation of existing data relations on the existing data context ceases to reveal previously unidentified objects, the maximally available object instance scope can be assumed to have been determined.

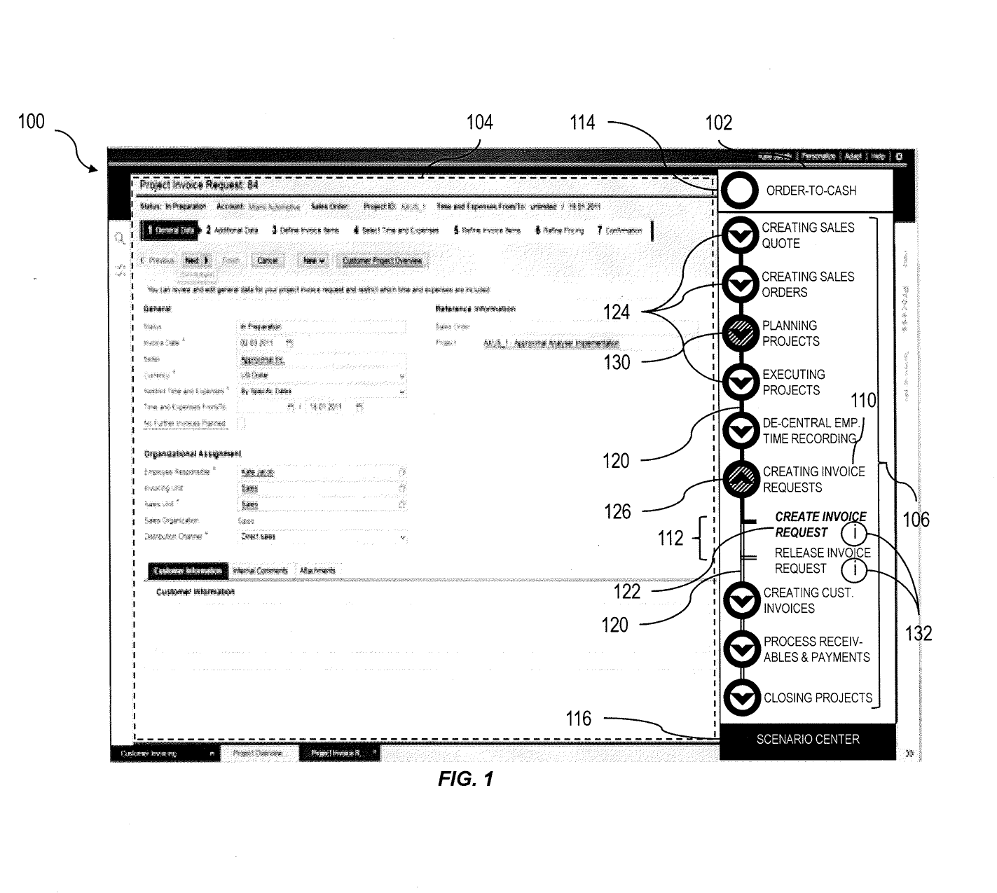

Aspects of the current subject matter can be used in conjunction with a graphical navigation view of a business scenario, for example one in which user interface elements provide guidance regarding where a specific business process feature fits within an organization-specific business scenario as well as status information regarding individual business process features (e.g. a business process, a process step, a sub-process, a sub-process step within a sub-process, an action, a task, a transaction, etc.). FIG. 1 illustrates a non-limiting example of a user interface 100 that includes a linear single scenario view showing a single business scenario as a linear sequence of business process features. The structure of the business scenario can condensed into a linear view, even though the actual flow of business process features necessary to complete an instance of the business scenario often involves explicit parallelism, decisions, loops, event driven changes in control flow, exceptions, and the like. Consistent with implementations of the current subject matter, any viable approach can be used to shape a business scenario into such a linear view.

As shown in FIG. 1, a scenario navigation pane 102 and a work pane 104 can be concurrently displayed in the user interface 100. A plurality of first user interface elements 106 can be displayed in the process navigation pane 102 and arranged in a linear progression to represent the linear sequence of business process features in the process model of the currently actively business process. A first user interface element 110 corresponding to a business scenario having additional business processes or other business process features 106 can be expanded as shown in FIG. 1 to display additional user interface elements 112 corresponding to the process steps or other business process features of the business scenario. Also as shown in FIG. 1, the currently active business scenario can be identified by one or more scenario identifier user elements 114. A scenario browser user interface element 116 can link to an upper level scenario landscape overview map to display an overall scenario landscape map showing intersections between processes and providing links to navigate to the other scenarios in the scenario landscape.

The first user interface elements 106 can optionally be displayed in a manner similar to a transit route map with each business process or other business process feature being represented like a stop on the route. In this manner, a familiar visual format can rapidly convey additional information about a current context within a specific instance of the business scenario as well as status information about the various business processes or other business process features along the “route” to completion of the instance. For example, a route line 120 connecting the “stops” can be presented with a first visual effect (e.g. color, brightness, shade, dots or dashes, etc.) up to the “stop” representing the process step that is currently “active” with related functionality being provided in the work pane 104. The currently active business process feature can be further indicated using textual or visual cues in the navigation pane 102, such as for example color, shading, font, a highlighting box, etc. As a non-limiting example, the name of the business process feature displayed in conjunction with the user interface element 122 corresponding to the currently active business process feature in FIG. 1 is formatted in a bold and italicized font. A different second visual effect can be used for the route line 120 leading to the “stops” past the currently active business process feature. The icons 124 used to represent the “stops” in the process navigation pane 102 can also include visual cues to inform a user about status, other business process feature that are included within the currently displayed business process feature user interface elements and that can be revealed by a user action to expand the route map, or the like.

Also in the example shown in FIG. 1, the expanded business process feature 110 can be a sub-scenario or business process or alternatively an intersecting business process or other business process feature that includes additional process business process features that are part of a second business scenario. The additional business process features can be illustrated by first user elements 112 incorporated directly into the route map without branching to maintain the linear progression of the scenario model. The first user interface element 126 representing the “stop” corresponding to this business process feature 110 can include a different visual presentation than other non-intersecting “stops” and can further include other visual presentation features to indicate that it is currently expanded as shown in FIG. 1. The “stop” first user interface element 130 corresponding to another business process or otherwise expandable business process feature (e.g. planning projects in the example of FIG. 1) can include features indicating this expandability, but that it currently is not expanded. Additional first user interface elements 132 (e.g. the “i” icons shown in FIG. 1) can provide additional details about one or more of the business process features 106.

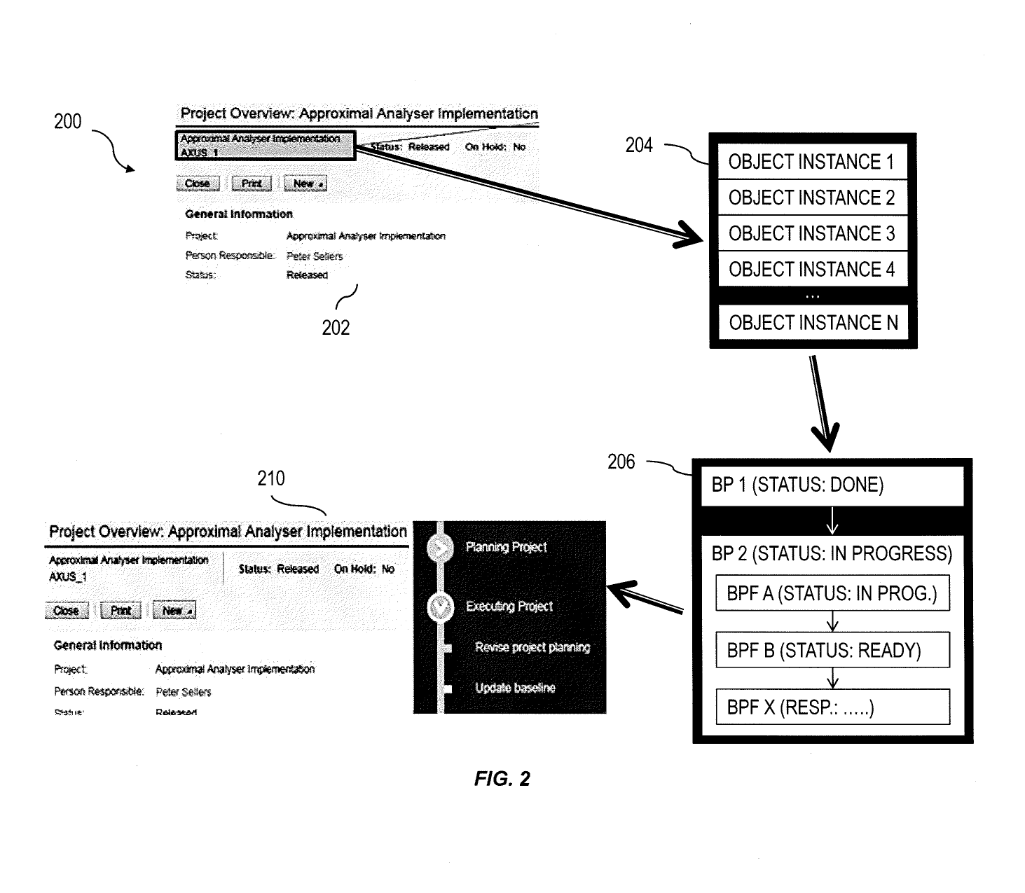

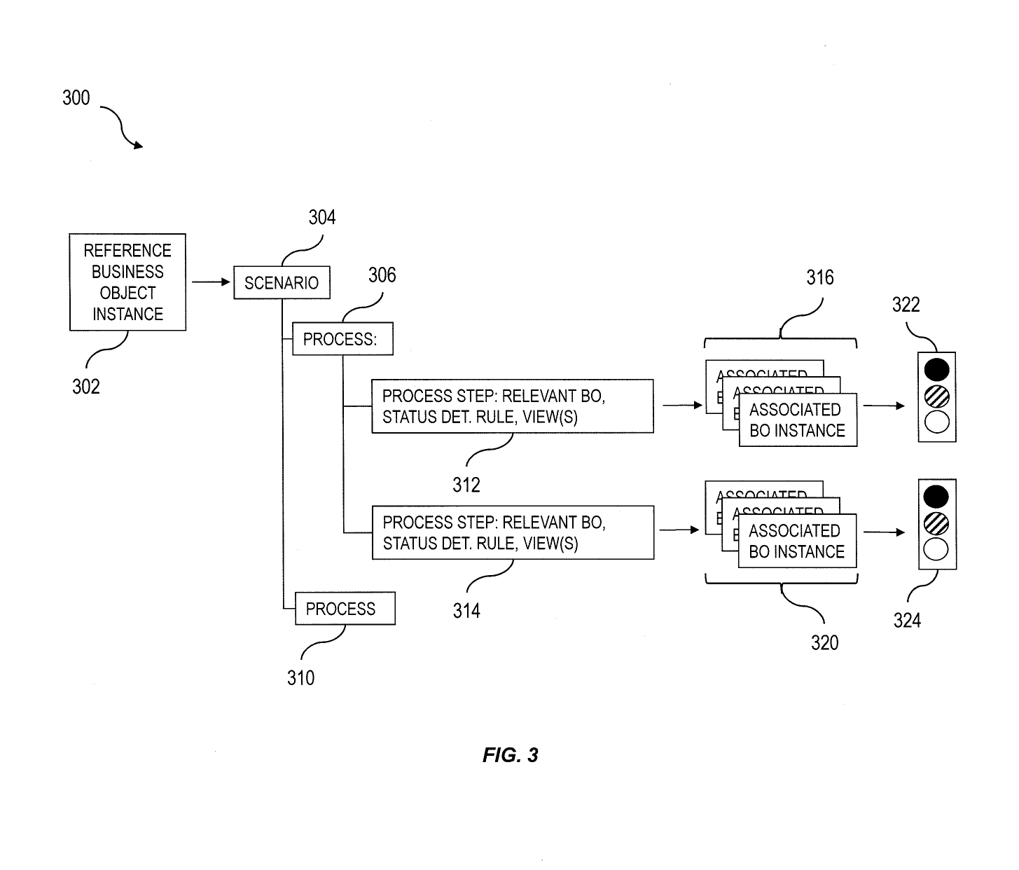

FIG. 2 and FIG. 3 show diagrams respectively illustrating a graphical process flow 200 and an exemplary modeling framework 300 via which instances of other business objects related to a current application context can be identified and current statuses of business process features of a currently active instance of a business scenario can be determined. As shown in FIG. 2, a currently active business application 202 (e.g. a transaction screen, a data entry screen, a document, etc.) can act as a seed for building a current use context of the business software architecture. A set of data derivation rules stored in a meta-model can be applied to compare the seed to a set of business objects 204 that are retained in active memory by the business software architecture. By retaining all instances of business objects relevant to live instances of business processes or scenarios and optionally to completed instances of business processes or scenarios in the organization's business configuration, the comparing can result in populating a data context that includes all instances of business objects relevant to the current use context. This data context can be used to evaluate status rules, responsibility rules, etc. to build a set of up-to-date business scenario instance information relevant to a set of process or scenario instances 206 (e.g. completed, in-progress, and ready to be performed) related to the current use context. This up-to-date instance information can be added to the navigation pane 102 to provide insight to the user about and potential manipulation options related to the current process or scenario instance.

As shown in FIG. 3, the seed generated from the currently active business application 202 can include identification of a reference business object 302. The type of the reference business object 302 can be linked to a business scenario 304, which can be a set of business processes including a first business process 306 and optionally a second business process 310 and/or additional business processes or business process features. Once it is determined, for example using an approach as discussed herein or by some other approach, that the first business process 306 is related to the reference business object, the business process features 312, 314 of that business process 306 are identified, for example based on a definition of the business process 306. Each business process feature can include one or more corresponding (e.g. relevant) business objects; status determining rules; user interface screens; elements, views, user roles, etc.; and the like. Each such corresponding element can in turn have associated with it or otherwise point to one or more business object instances 316 that are associated with a specific instance of the business process 306 to which the reference business object instance 302 has been determined to correspond. Based on a set of rules or some other algorithmic determination, a current status 322,324 of one or more of the process steps 312, 314 can be determined for the specific instance of the business process 306. In one example, the status can be one or more of ready or not ready (e.g. for execution), in progress, completed, authorized or not authorized, locked, escalated, or the like. Each status value can include a corresponding rule attached to determine whether or not the given status value is attained. A user can be enabled to define his or her own status values and optionally the corresponding rules that activate the status value. As discussed further below, a scenario navigation user interface feature or features can be provided that shows a user where in the specific scenario instance he or she is currently working and that optionally also further shows the determined status for at least one of the process steps or other business process features 312, 314 for that instance of the business process 306. In one example, the showing of the business process feature status can be via one or more icons. For example, a traffic signal icon could indicate a different pattern or color (e.g. red, yellow, green, etc.) corresponding to each status for the one or more business process features.

In making the calculation of status for a given process step 312, 314, data extracted from more than one associated business object instance can be aggregated. For example, the designation of process steps in the business process definition can include steps that have require more than one task or sub-step to complete and that can therefore rely on data from multiple business object instances. Data relating to stepwise linkages of the associated business object instances as they relate to a given process step or sequence of process steps can be queried and used to determine status information. Alternatively, a more efficient calculation of status information can be obtained in some examples by directly querying business subject via their header information, which can in some cases include sufficient information about related business object types to obviate the need to retrieve and read the entirety of each business object instance.

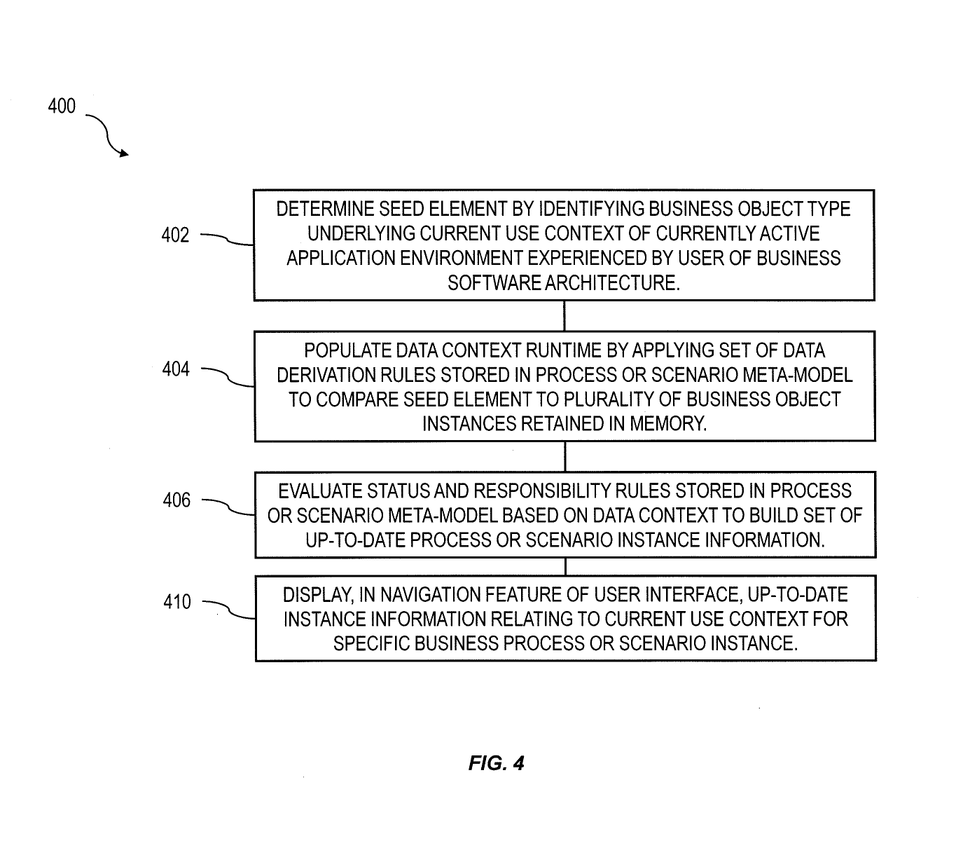

FIG. 4 shows a process flow chart 400 illustrating a method having one or more features consistent with implementations of the current subject matter. At 402, a seed element is determined by identifying a business object type underlying a current use context of a currently active application environment experienced by a user of a business software architecture. At 404, a data context is populated at runtime by applying a set of data derivation rules stored in a process or scenario meta-model to compare the seed element to a plurality of business object instances retained in memory. Status and responsibility rules stored in the process or scenario meta-model are evaluated at 406 based on the data context to build a set of up-to-date process or scenario instance information. At 410, up-to-date instance information relating to the current use context is displayed, for example via a process navigation user interface configuration presentable on a computer display device.

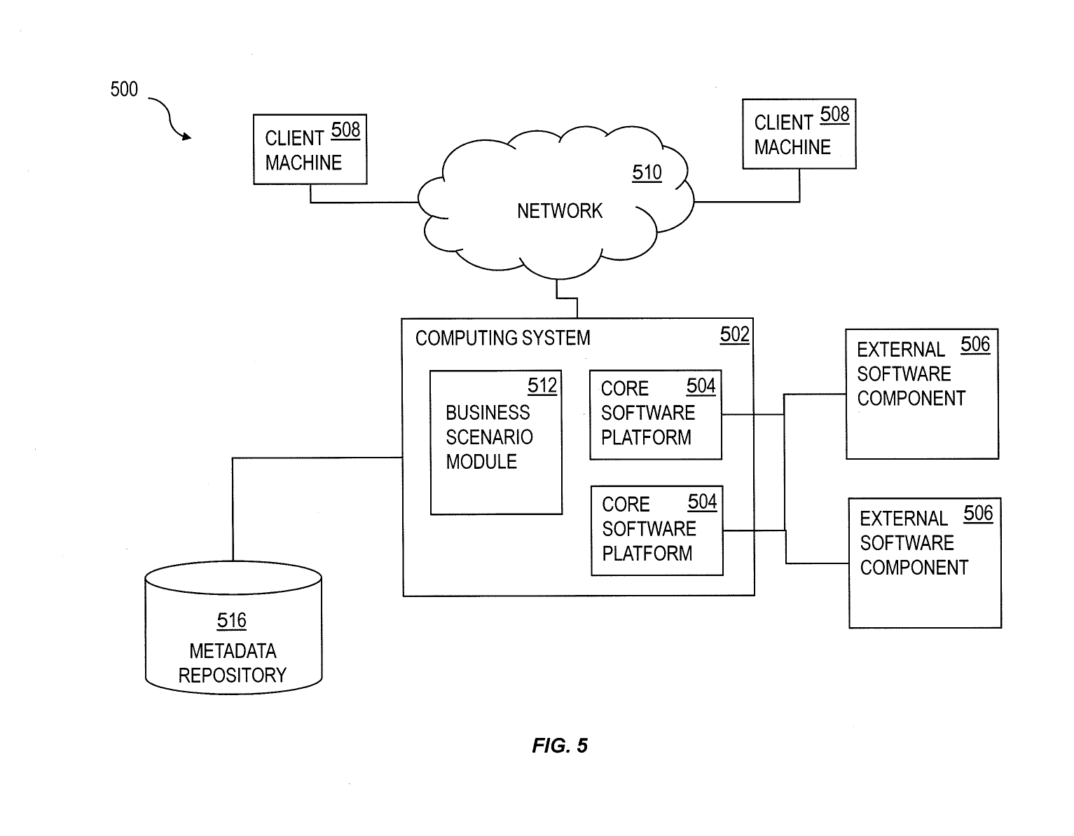

The core software platform of an ERP or other business software architecture can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available ERP solution to work with organization-specific business processes and functions is feasible. FIG. 5 shows a diagram of a system consistent with such an implementation. A computing system 502 can include one or more core software platform modules 504 providing one or more features of the ERP system. The computing system can also aggregate or otherwise provide a gateway via which users can access functionality provided by one or more external software components 506, which can optionally be provided or supported by service providers external to the core software platform modules 504. Client machines 508 can access the computing system, either via a direct connection, a local terminal, or over a network 510 (e.g. a local area network, a wide area network, a wireless network, the Internet, or the like). A business scenario guidance and recording module 512 can be hosted on the computing system 502 or alternatively, on an external system accessible over a network connection. The business scenario guidance and recording module 512 can optionally include one or more discrete software and/or hardware modules that perform operations such as those described herein.

The business scenario guidance and recording module 512 can access one or more metadata repositories 516 and/or other data repositories that can store the definition of business processes and business configuration as well as data, metadata, master data, etc. relating to definitions of the business processes, the business configuration, and/or concrete instances of the data objects (e.g. business objects) that are relevant to a specific instance of the business process or scenario. In some examples, the definition can optionally be stored as a business object. In some implementations, the business object can include a template definition of a standard business process or scenario. The template definition that can optionally be modified via one or more extensions that are stored in the one or more metadata repositories 516.

Smaller organizations can also benefit from use of ERP functionality. However, such an organization may lack the necessary hardware resources, IT support, and/or consulting budget necessary to make use of a standalone ERP software architecture product and can in some cases be more effectively served by a software as a service (SaaS) arrangement in which the ERP system architecture is hosted on computing hardware such as servers and data repositories that are maintained remotely from the organization's location and accessed by authorized users at the organization via a thin client, such as for example a web browser, over a network.

In a software delivery configuration in which services of an ERP system are provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

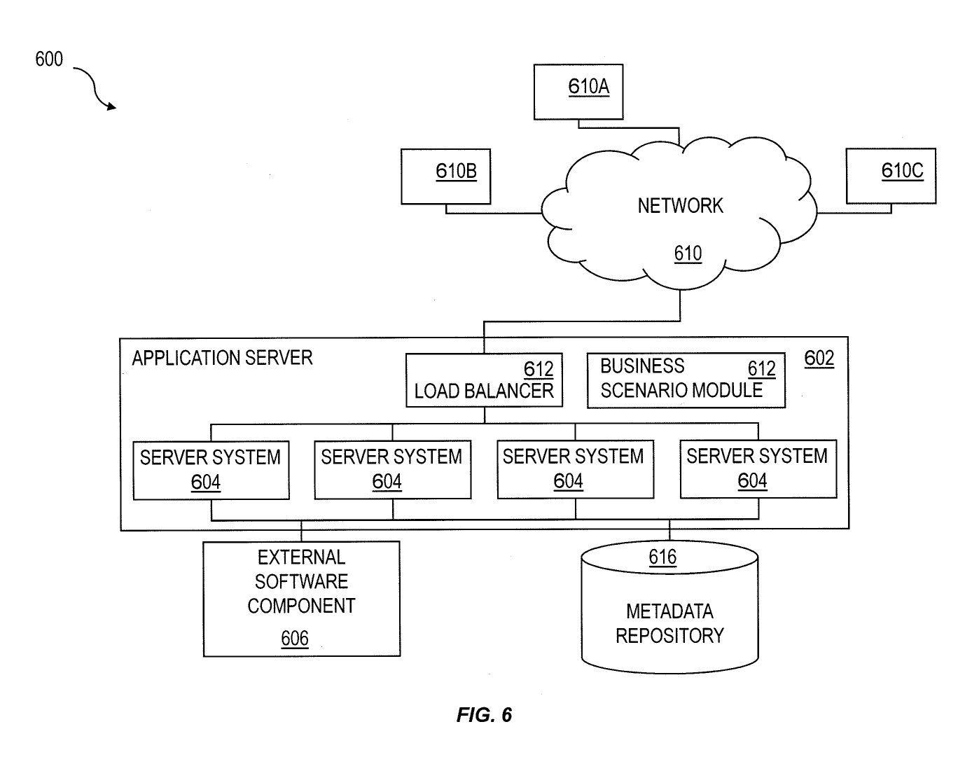

FIG. 6 shows a block diagram of a multi-tenant implementation of a software delivery architecture 600 that includes an application server 602, which can in some implementations include multiple server systems 604 that are accessible over a network 510 from client machines operated by users at each of multiple organizations 610A-610C (referred to herein as “tenants” of a multi-tenant system) supported by a single software delivery architecture 600. For a system in which the application server 602 includes multiple server systems 604, the application server can include a load balancer 612 to distribute requests and actions from users at the one or more organizations 610A-610C to the one or more server systems 604. Instances of the core software platform 504 (not shown in FIG. 6) can be executed in a distributed manner across the server systems 604. A user can access the software delivery architecture across the network using a thin client, such as for example a web browser or the like, or other portal software running on a client machine. The application server 602 can access data and data objects stored in one or more data repositories 516. The application server 602 can also serve as a middleware component via which access is provided to one or more external software components 506 that can be provided by third party developers.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 602 that includes multiple server systems 604 that handle processing loads distributed by a load balancer 612. Potential benefits from such an arrangement can include, but are not limited to, high and reliably continuous application server availability and minimization of unplanned downtime, phased updating of the multiple server systems 604 to permit continuous availability (one server system 604 can be taken offline while the other systems continue to provide services via the load balancer 612), scalability via addition or removal of a server system 604 that is accessed via the load balancer 612, and de-coupled lifecycle processes (such as for example system maintenance, software upgrades, etc.) that enable updating of the core software independently of tenant-specific customizations implemented by individual tenants.

As in the example illustrated in FIG. 5, the metadata repository 516 can store a business object that represents a template definition of a standard business process. Each individual tenant 610A-610C can customize that standard template according to the individual business process features specific to business of the organization to which that tenant is assigned. Customizations can be stored as extensions in the metadata repository.

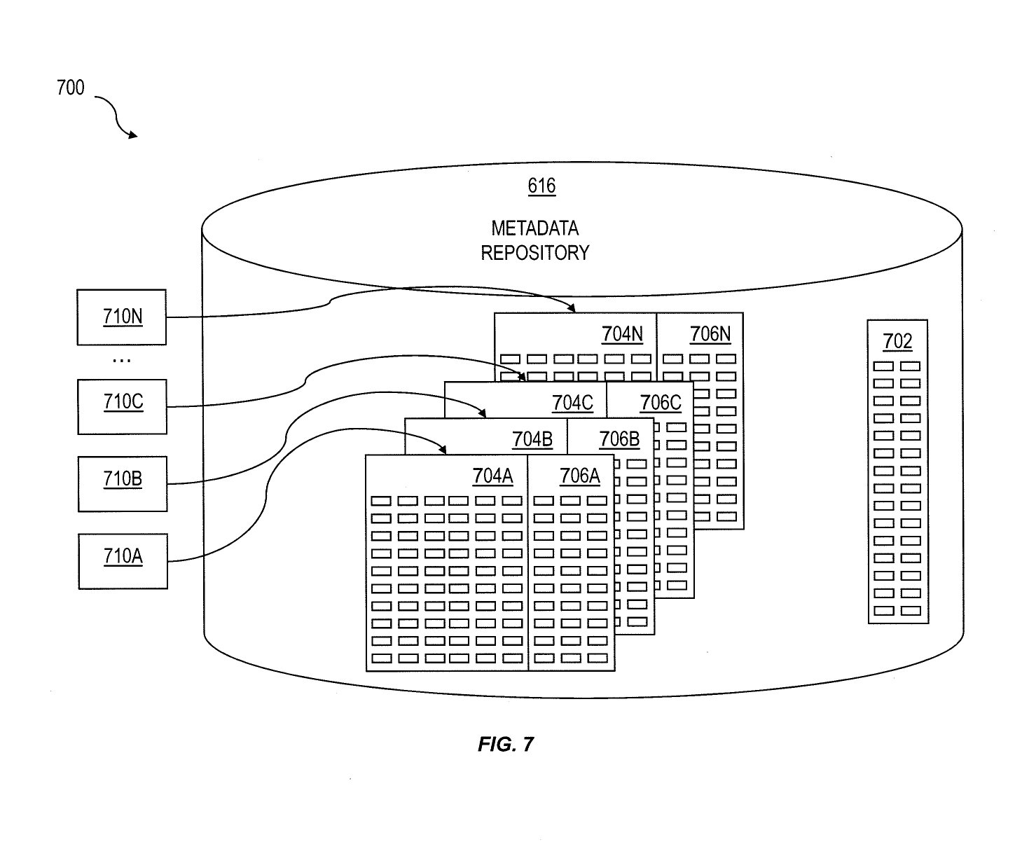

To provide for customization of the business process for each of multiple organizations supported by a single software delivery architecture 600, the data and data objects stored in the metadata repository 516 and/or other data repositories that are accessed by the application server 602 can include three types of content as shown in FIG. 7: core software platform content 702 (e.g. a standard definition of a business process), system content 704 and tenant content 706. Core software platform content 702 includes content that represents core functionality and is not modifiable by a tenant. System content 704 can in some examples be created by the runtime of the core software platform and can include core data objects that store concrete data associated with specific instances of a given business process and that are modifiable with data provided by each tenant. The data retained in these data objects are tenant-specific: for example, each tenant 610A-610N can store information about its own inventory, sales order, etc. Tenant content 706A-706N includes data objects or extensions to other data objects that are customized for one specific tenant 610A-610N to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 706 can reflect tenant-specific modifications or changes to a standard template definition of a business process as well as tenant-specific customizations of the business objects that relate to individual process step (e.g. records in generated condition tables, access sequences, price calculation results, other tenant-specific values, or the like). A combination of the software platform content 702 and system content 704 and tenant content 706 of a specific tenant are accessed to provide the business process definition and/or the status information relating to a specific instance of the business process according to customizations and business data of that tenant such that each tenant is provided access to a customized solution whose data are available only to users from that tenant.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A computer program product comprising a machine-readable medium non-transitorily storing instructions that, when executed by at least one programmable processor, cause the at least one programmable processor to perform operations comprising:
determining a seed element by identifying a reference business object type underlying a current use context of a currently active application environment experienced by a user of a business software architecture,
identifying a link between the reference business object type and a business scenario or business process of an organization that uses the business software architecture;
building, dynamically at runtime, a full data context of a scenario or process instance of the identified business scenario or business process, the building comprising determining the scenario or process instance based on the current use context of the currently active application environment and deriving and retaining in system memory instances of all dependent business objects related to the scenario or process instance, the deriving comprising accessing a meta-model of the business scenario or business process, the meta-model comprising a list of data entities on which the business scenario or business process operates;
populating, at runtime, the data context by applying a set of data derivation rules stored in the meta-model to compare the seed element to the dependent business object instances retained in memory;
evaluating status and responsibility rules stored in the meta-model based on the data context to build a set of up-to-date process or scenario instance information; and
displaying, via a scenario navigation user interface configuration presentable on a computer display device, up-to-date instance information relating to the current use context for the scenario or process instance related to the current use context.

2. A computer program product as in claim 1, wherein the determining the seed element further comprises identifying a reference business object underlying the currently active application environment.

3. A computer program product as in claim 1, wherein the populating comprises identifying, from the plurality of in-memory business object instances, other specific business object instances that are related to the specific instance of the business process or scenario.

4. A computer program product as in claim 1, wherein the operations further comprise updating the meta-model based on a received user input.

5. A computer program product as in claim 1, wherein the scenario navigation user interface configuration comprises a navigation pane of the user interface that comprises a plurality of first user interface elements illustrating a sequence of a plurality of business process features required for completion of the specific instance of the business process or scenario and a status of one or more of the plurality of business process features for the specific instance of the business process or scenario.

6. A computer program product as in claim 5, wherein the navigation pane is concurrently displayed with a work pane comprising second user interface elements related to the currently active application environment.

7. A system comprising:
at least one programmable processor; and
a machine-readable medium storing instructions that, when executed by the at least one processor, cause the at least one programmable processor to perform operations comprising:
determining a seed element by identifying a reference business object type underlying a current use context of a currently active application environment experienced by a user of a business software architecture,
identifying a link between the reference business object type and a business scenario or business process of an organization that uses the business software architecture;
building, dynamically at runtime, a full data context of a scenario or process instance of the identified business scenario or business process, the building comprising determining the scenario or process instance based on the current use context of the currently active application environment and deriving and retaining in system memory instances of all dependent business objects related to the scenario or process instance, the deriving comprising accessing a meta-model of the business scenario or business process, the meta-model comprising a list of data entities on which the business scenario or business process operates;
populating, at runtime, the data context by applying a set of data derivation rules stored in the meta-model to compare the seed element to the dependent business object instances retained in memory;
evaluating status and responsibility rules stored in the meta-model based on the data context to build a set of up-to-date process or scenario instance information; and
displaying, via a scenario navigation user interface configuration presentable on a computer display device, up-to-date instance information relating to the current use context for the scenario or process instance related to the current use context.

8. A system as in claim 7, wherein the determining the seed element further comprises identifying a reference business object underlying the currently active application environment.

9. A system as in claim 7, wherein the populating comprises identifying, from the plurality of in-memory business object instances, other specific business object instances that are related to the specific instance of the business process or scenario.

10. A system as in claim 7, wherein the operations further comprise updating the meta-model based on a received user input.

11. A system as in claim 7, wherein the scenario navigation user interface configuration comprises a navigation pane of the user interface that comprises a plurality of first user interface elements illustrating a sequence of a plurality of business process features required for completion of the specific instance of the business process or scenario and a status of one or more of the plurality of business process features for the specific instance of the business process or scenario.

12. A system as in claim 11, wherein the navigation pane is concurrently displayed with a work pane comprising second user interface elements related to the currently active application environment.

13. A computer-implemented method comprising:
determining a seed element by identifying a reference business object type underlying a current use context of a currently active application environment experienced by a user of a business software architecture,
identifying a link between the reference business object type and a business scenario or business process of an organization that uses the business software architecture;
building, dynamically at runtime, a full data context of a scenario or process instance of the identified business scenario or business process, the building comprising determining the scenario or process instance based on the current use context of the currently active application environment and deriving and retaining in system memory instances of all dependent business objects related to the scenario or process instance, the deriving comprising accessing a meta-model of the business scenario or business process, the meta-model comprising a list of data entities on which the business scenario or business process operates;
populating, at runtime, the data context by applying a set of data derivation rules stored in the meta-model to compare the seed element to the dependent business object instances retained in memory;
evaluating status and responsibility rules stored in the meta-model based on the data context to build a set of up-to-date process or scenario instance information; and
displaying, via a scenario navigation user interface configuration presentable on a computer display device, up-to-date instance information relating to the current use context for the scenario or process instance related to the current use context;
wherein the determining, the identifying, the building, the populating, the evaluating, and the displaying are performed by at least one programmable processor.

14. A computer-implemented method as in claim 13, wherein the determining the seed element further comprises identifying a reference business object underlying the currently active application environment.

15. A computer-implemented method as in claim 13, wherein the populating comprises identifying, from the plurality of in-memory business object instances, other specific business object instances that are related to the specific instance of the business process or scenario.

16. A computer-implemented method as in claim 13, further comprising updating the meta-model based on a received user input.

17. A computer-implemented method as in claim 13, wherein the scenario navigation user interface configuration comprises a navigation pane of the user interface that comprises a plurality of first user interface elements illustrating a sequence of a plurality of business process features required for completion of the specific instance of the business process or scenario and a status of one or more of the plurality of business process features for the specific instance of the business process or scenario.

18. A computer-implemented method as in claim 17, wherein the navigation pane is concurrently displayed with a work pane comprising second user interface elements related to the currently active application environment.

19. (canceled)
